(19) United States
(12) Patent Application Publication
(10) Pub. No.: US 2016/0340911 A1
(43) Pub. Date: Nov. 24, 2016

(54) CONNECTOR ASSEMBLY FOR MODULAR GROUND COVERING PANELS

(71) Applicants: 670988 NB Inc., Tracadie-Sheila (CA); GSM Solutions Inc., Edmonton (CA)

(72) Inventor: Neri Jean, Tracadie-Sheila (CA)

(21) Appl. No.: 14/715,709

(22) Filed: May 19, 2015

(51) Int. Cl. E04F 15/02; F16B 37/04

(52) U.S. Cl. CPC E04F 15/02038; F16B 37/044

(57) ABSTRACT

A system for constructing a load bearing surface includes a plurality of modular ground covering panels. Along at least one first side edge of each of the panels, the lower surface projects beyond the upper surface to define a lower peripheral tab. Along at least one second side edge of each of the panels, the upper surface projects beyond the lower surface to define an upper peripheral tab. The lower peripheral tab of one of the panels and the upper peripheral tab of another one of the panels overlappingly engage so that the upper surfaces of the panels are in adjoining relation to form the load bearing surface. A connector assembly includes a first connection element fixed to the lower peripheral tab, and a second connection element that releasably fastens the upper peripheral tab to the first connection element to secure the panels together.

### FIELD

The present disclosure relates generally to modular ground covering panels that are constructed to form a load bearing surface.

### BACKGROUND

The following paragraphs are not an admission that anything discussed in them is prior art or part of the knowledge of persons skilled in the art.

U.S. Pat. No. 6,511,257 describes a reusable mat system for the construction of load bearing surfaces, such as temporary roadways and equipment support surfaces, over unstable or unsubstantial terrain, comprising durable, interlocking individual mats which can be quickly and easily installed in a single application, and which can thereafter be easily removed and stored until needed again. The individual mats interlock on all sides to form stable and continuous load bearing surfaces, and exhibit favorable traction characteristics.

U.S. Pat. No. 6,652,183 describes a road mat that includes a body having a first end, a second end, a first face and a second face. A first coupling is positioned at the first end has an outwardly extending portion extending outwardly from the first end adjacent to the second face, an angled portion extending from a remote end of the outwardly extending portion toward but not past the first face, and an inwardly extending retaining lip extending from a remote end of the angled portion back toward the first end. A second coupling is positioned at the second end is similarly configured with an outwardly extending portion extending outwardly from the second end adjacent to the first face, an angled portion and an inwardly extending retaining lip. The retaining lip of the second coupling engages the retaining lip of the first coupling preventing separation.

U.S. Pat. No. 7,303,800 describes a mat system with each mat having sloping lips which overlap with an adjacent mat's sloping lips and are secured by interlocking joints in the mats' lips and/or by captive locking pins to form an easily assembled and interconnected flat surface. In use, opposing ledges forms a slot within holes in the top overlapping lips to receive a captive locking pin. The pin is captive by mid body prongs which fix underneath the ledges in a mat's upper lip's holes, and the pin locks and unlocks with rotary turning of the pin resulting in the pin's keeper feet fixing underneath the similar ledges in the holes of the lower lip of an adjacent mat.

U.S. Pat. No. 7,413,374 describes a portable overlapping secured mat system with uniformly sized plastic mats joined together to form structural support surface for use by persons or equipment. The mats' edges have recessed upper and lower lips with finger projections extending from the upper lips sized to fit into holes of adjacent mats' lower lips securing the mats together when the front edge of the finger projections are moved into a recesses of the back wall of the hole.

U.S. Pat. No. 7,434,364 describes a wall panel arrangement. A pair of upright wall panels are each provided with a sidewardly spaced pair of generally parallel but inclined guide grooves extending vertically along the outer face of the upright frame edge rails. A connector assembly including a main activator rod having a pair of wedge members threaded thereon in spaced relationship therealong is positioned between the opposed upright edge rails. The wedge members have wedgelike edge flanges which protrude into the grooves of the opposed upright edge rails. Rotation of the activating rod causes the wedge members to simultaneously move relative to the rod in opposite directions between a first end position wherein the wedge members effect gripping engagement with the groove walls to simultaneously effect a drawing together of the edge rails and alignment thereof, and a second end position wherein the wedge members clampingly engage only a single edge rail to facilitate initial mounting of the connector assembly.

### INTRODUCTION

The following is intended to introduce the reader to the more detailed description that follows and not to define or limit the claimed subject matter.

According to an aspect of the present disclosure, a system for constructing a load bearing surface may include: at least first and second modular ground covering panels, each of the panels including upper and lower surfaces, wherein along at least one first side edge of each of the panels the lower surface projects beyond the upper surface to define a lower peripheral tab, wherein along at least one second side edge of each of the panels the upper surface projects beyond the lower surface to define an upper peripheral tab, and wherein the lower peripheral tab of one of the panels and the upper peripheral tab of another one of the panels are configured to overlappingly engage so that the upper surfaces of the panels are in adjoining relation to form the load bearing surface; and at least one connector assembly including a first connection element fixed to the lower peripheral tab, and a second connection element that releasably fastens the upper peripheral tab to the first connection element to secure the panels together. The second connection element may be fastened to and unfastened from the first connection element generally from above the upper surfaces of the panels. The upper peripheral tab may include at least one aperture, and the second connection element may include a bolt that extends through the aperture. A head of the bolt may be accessible from above the upper surfaces of the panels. The first connection element may include a nut configured to receive the bolt, and the nut may be retained in position relative to the lower peripheral tab so that rotation of the nut about a bolt axis is not permitted. The bolt and the nut may include complementary threads that facilitate the second connection element being releasably fastened to the first connection element.

Other aspects and features of the teachings disclosed herein will become apparent, to those ordinarily skilled in the art, upon review of the following description of the specific examples of the present disclosure.

### BRIEF DESCRIPTION OF THE DRAWINGS

The drawings included herewith are for illustrating various examples of apparatuses and methods of the present disclosure and are not intended to limit the scope of what is taught in any way. In the drawings:

FIGS. 1 and 2 are upper and lower perspective views, respectively, of an example of a modular ground covering panel;

FIG. 3 is an upper perspective view of a plurality of the modular ground covering panel of FIGS. 1 and 2, and constructed to form a load bearing surface;

FIG. 4 is an exploded view of an example of a connector assembly for use with the modular ground covering panel of FIGS. 1 and 2;

FIG. 5 is a sectional view along line 5-5 in FIG. 3;

FIG. 6 is a lower perspective view of examples of a bolt, a brace plate, a brace plate clip and a nut;

FIG. 7 is a side view of the bolt of FIG. 6;

FIG. 8 is a sectional view along line 8-8 in FIG. 7;

FIGS. 9 and 10 are top and side views, respectively, of an example of a connector hub for use with the bolt, the brace plate, the brace plate clip and the nut of FIG. 6;

FIG. 11 is a sectional view along line 11-11 in FIG. 9; and

FIG. 12 is a sectional view along line 12-12 in FIG. 11.

### DETAILED DESCRIPTION

Various apparatuses or methods are described below to provide an example of an embodiment of each claimed invention. No embodiment described below limits any claimed invention and any claimed invention may cover apparatuses and methods that differ from those described below. The claimed inventions are not limited to apparatuses and methods having all of the features of any one apparatus or method described below or to features common to multiple or all of the apparatuses or methods described below. It is possible that an apparatus or method described below is not an embodiment of any claimed invention. Any invention disclosed in an apparatus or method described below that is not claimed in this document may be the subject matter of another protective instrument, for example, a continuing patent application, and the applicant(s), inventor(s) and/or owner(s) do not intend to abandon, disclaim or dedicate to the public any such invention by its disclosure in this document.

In general, the concepts described herein pertain to a load bearing surface formed by a plurality of modular ground covering panels having upper surfaces arranged in adjoining relation. Each of the panels may include at least one peripheral tab that overlapping engages a peripheral tab of at least one adjacent panel. A plurality of connector assemblies secures the panels together. Each of the connector assemblies includes a first connection element that is fixed to a peripheral tab of one of the panels, and a second connection element that releasably fastens the corresponding peripheral tab of the adjacent panel to the first connection element.

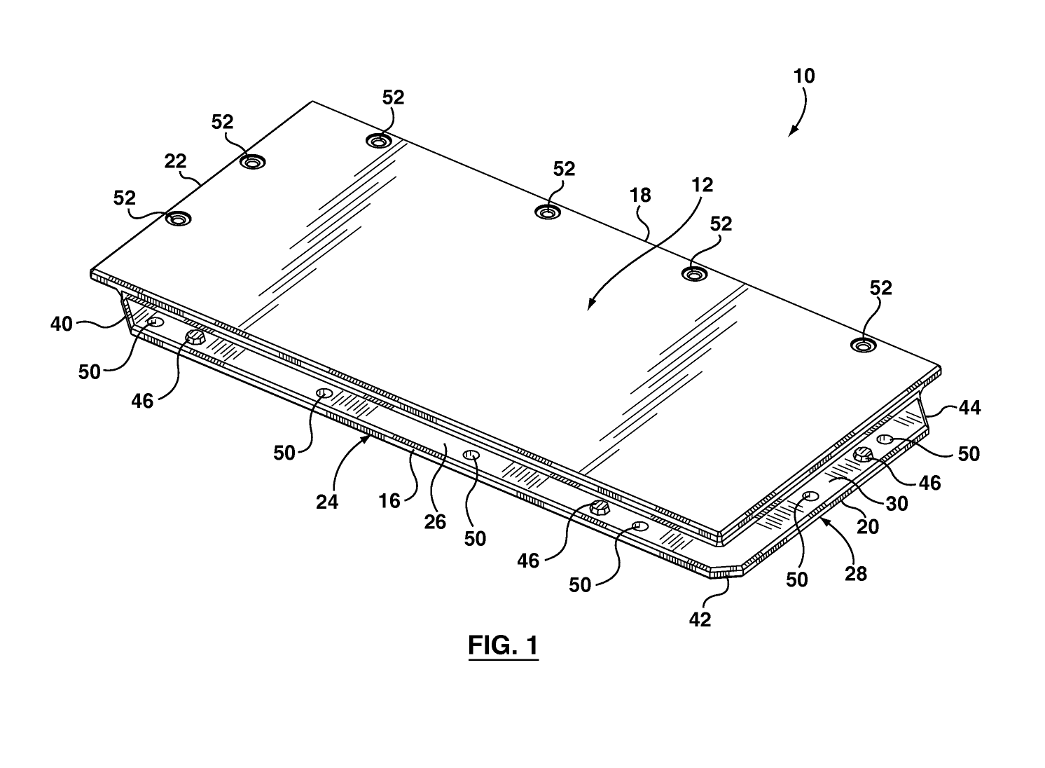

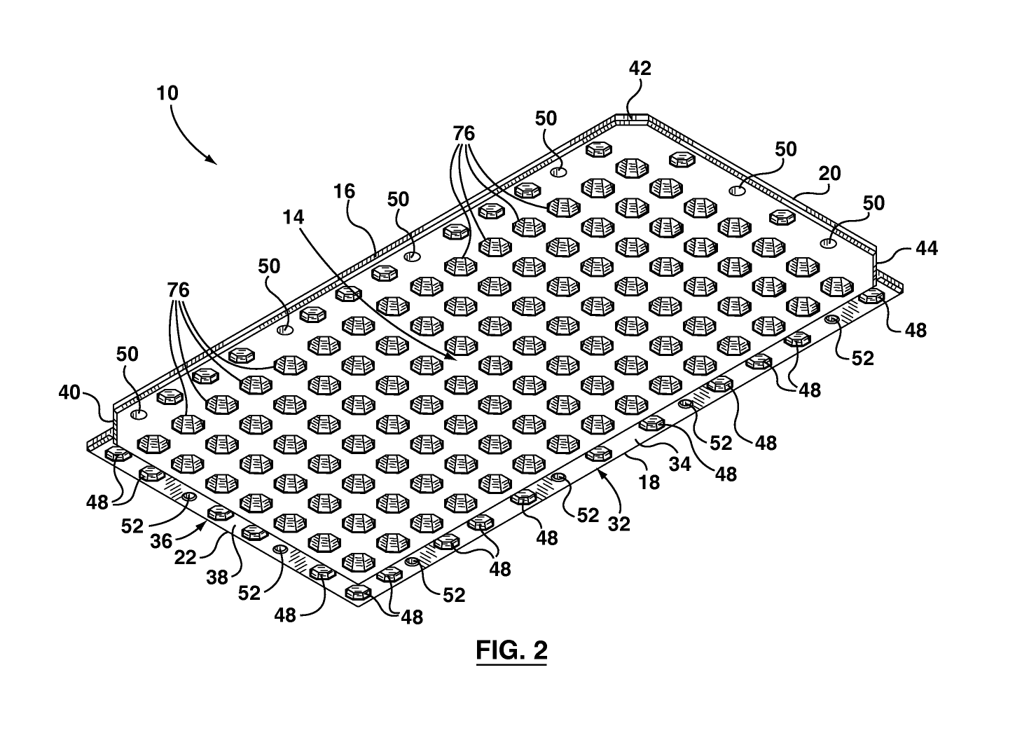

Referring to FIGS. 1 and 2, an example of a modular ground covering panel is shown generally at reference numeral 10. The panel 10 includes an upper surface 12, and a lower surface 14 arranged spaced apart from the upper surface 12 and generally parallel thereto.

The panel 10 may be formed of plastic material, for example but not limited to, low-density polyethylene (LDPE). The panel 10 may be hollow, and may be manufactured using a rotational molding process. Optionally, the upper surface 12 may include traction features, such as a repeating diamond plate pattern or the like. The panel 10 may be configured according to various sizes and shapes, and the present teachings should not be limited to the particular configuration illustrated in the drawings. In some examples, the panel 10 may be produced to have dimensions of about 85″×180″×6″. In some examples, the panel 10 may be produced to have dimensions of about 90″×171″×4″.

In the example illustrated, the panel 10 includes first, second, third and fourth side edges 16, 18, 20, 22. The first side edge 16 extends between bevel corners 40, 42; the third side edge 20 extends between bevel corners 42, 44. The first and second side edges 16, 18 extend generally in parallel in a longitudinal direction between the third and fourth side edges 20, 22. The third and fourth side edges 20, 22 extend generally in parallel in a lateral direction between the first and second side edges 16, 18.

In the example illustrated, along the first side edge 16, the lower surface 14 projects beyond the upper surface 12 to define a lower peripheral tab 24 (FIG. 1). The lower peripheral tab 24 presents an elongate flange surface 26 generally along a longitudinal extent of the panel 10 between the third and fourth side edges 20, 22. Furthermore, along the third side edge 20, the lower surface 14 projects beyond the upper surface 12 to define a lower peripheral tab 28 (FIG. 1). The lower peripheral tab 28 presents an elongate flange surface 30 generally along a lateral extent of the panel 10 between the first and second side edges 16, 18. The flange surfaces 26, 30 may be generally parallel to a plane defined by the upper surface 12.

Conversely, along the second side edge 18, the upper surface 12 projects beyond the lower surface 14 to define an upper peripheral tab 32 (FIG. 2). The upper peripheral tab 32 presents an elongate flange surface 34 generally along a longitudinal extent of the panel 10 between the third and fourth side edges 20, 22. Moreover, along the fourth side edge 22, the upper surface 12 projects beyond the lower surface 14 to define an upper peripheral tab 36 (FIG. 2). The upper peripheral tab 36 presents an elongate flange surface 38 generally along a lateral extent of the panel 10 between the first and second side edges 16, 18. The flange surfaces 34, 38 may also be generally parallel to a plane defined by the upper surface 12.

Given two of the panels 10 arranged next to one another in a side-by-side relationship, the tabs 24, 32 are sized and shaped for overlapping engagement, with the flange surfaces 26, 34 in opposed relation. Similarly, given two of the panels 10 arranged next to one another in an end-to-end relationship, the tabs 28, 36 are sized and shaped for overlapping engagement, with the flange surfaces 30, 38 in opposed relation. Other arrangements for the panel 10 may be possible.

In the example illustrated, the panel 10 includes a plurality of first connection elements 50 spaced apart along the tabs 24, 28. The panel 10 also includes a plurality of apertures 52 spaced apart along the tabs 32, 36, extending between the upper surface 12 and the flange surfaces 34, 38. The apertures 52 may be positioned in corresponding registration with the first connection elements 50 of an adjacent panel 10, with either the flange surfaces 26, 34 or the flange surfaces 30, 38 being in opposed relation.

Optionally, as illustrated, the panel 10 may include protrusion elements 46 spaced apart along the tabs 24, 28. Complementary recess elements 48 are spaced apart along the tabs 32, 36, and receive the protrusion elements 46 to provide a means for quick positioning of panels 10 to be joined together, prior to being secured. A greater number of the recess elements 48 may be provided so as to allow options for a staggered arrangement of the panels 10.

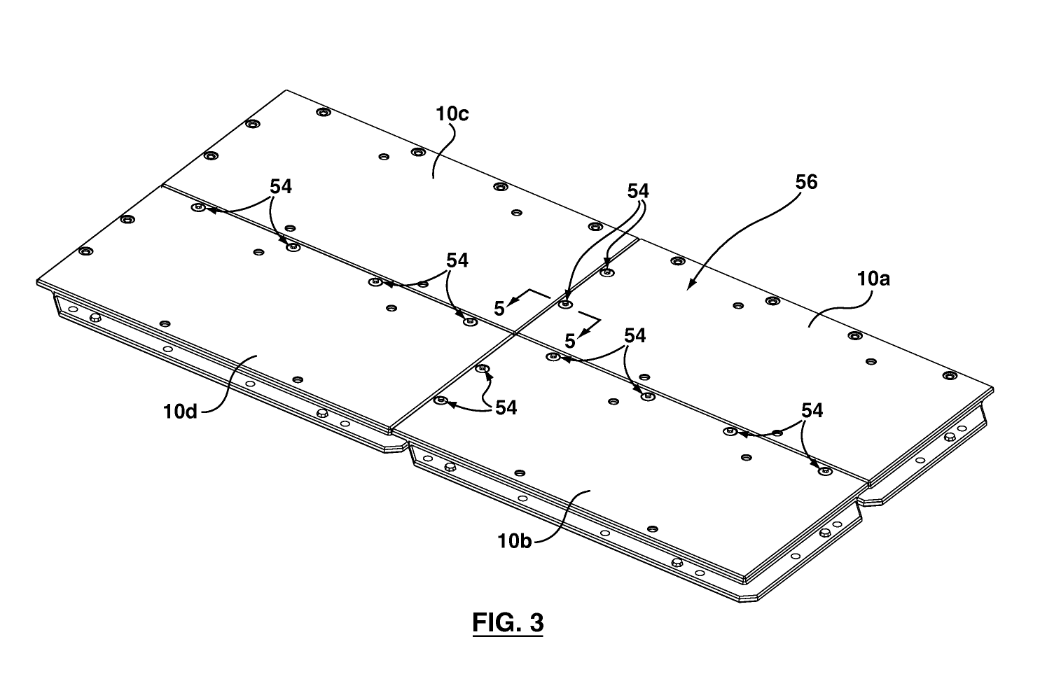

Referring now to FIG. 3, a system is shown consisting of four of the panels 10, denoted by reference numerals 10a, 10b, 10c and 10d. The panel 10a is arranged next to the panel 10b in a side-by-side relationship, whereas the panel 10a is arranged next to the panel 10c in an end-to-end relationship, etc. A plurality of connector assemblies 54 secure the panels 10a, 10b, 10c, 10d together in adjoining relation, so that the upper surfaces of the 10a, 10b, 10c, 10d form a load bearing surface 56. As illustrated, the connector assemblies 54 may be spaced apart along the side edges of the panels 10a, 10b, 10c, 10d at regular intervals.

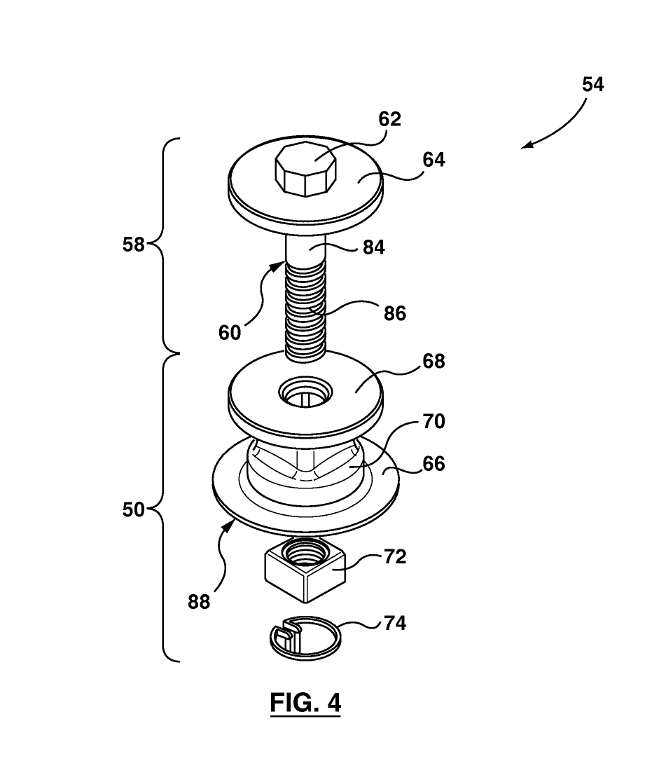

Referring to FIG. 4, the connector assembly 54 may include the first connection element 50, and a second connection element 58. In the example illustrated, the second connection element 58 includes a bolt 60 and a brace plate 64. The bolt 60 includes a head 62, a shaft portion 84 extending through the brace plate 64, and a threaded portion 86 below the shaft portion 84. In the example illustrated, the first connection element 50 includes a connector hub 88. The connector hub 88 is shown to include brace plates 66, 68, and a body 70 arranged between the brace plates 66, 68. The first connection element 50 is shown to further include a nut 72 retained by the body 70, and a clip 74 for retaining the nut 72 in the body 70. The threaded portion 86 of the bolt 60 and an interior of the nut 72 include complementary threads that facilitate the second connection element 58 being releasably fastened to the first connection element 50.

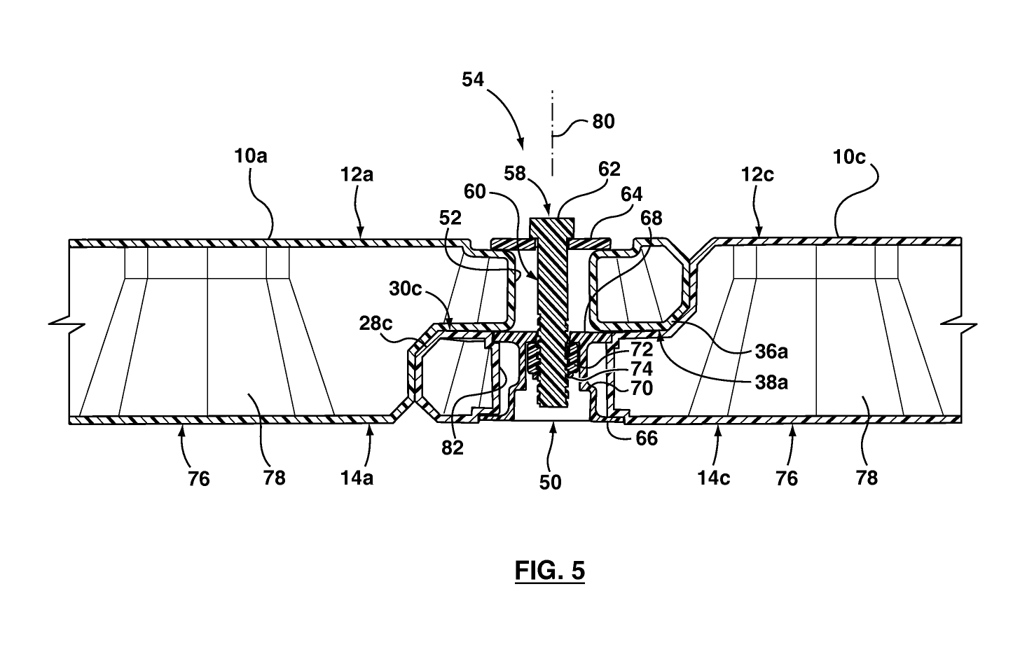

Referring now to FIG. 5, the second connection element 58 is shown received in the tab 36a in the aperture 52 that extends between the upper surface 12a and the flange surface 38a. The brace plate 64 is shown mounted to a recess in the upper surface 12a of the panel 10a so that it is generally flush with the upper surface 12a.

The first connection element 50 is shown received in the tab 28c in an aperture 82 that extends between the lower surface 14c and the flange surface 30c. The brace plate 66 is shown mounted to a recess in the lower surface 14c of the panel 10c so that it is generally flush with the lower surface 14c, and the brace plate 68 is shown mounted to a recess in the flange surface 30c of the tab 28c so that it is generally flush with the flange surface 30c. Spacing between the brace plates 66, 68 may be selected so that the tab 28c is compressed therebetween. The brace plates 64, 66, 68 distribute forces between the connector assembly 54 and the tabs 36a, 28c. Accordingly, the first connection element 50 may be rigidly fixed to the tab 28c, so that rotation of the first connection element 50 (including the nut 72), e.g., about a bolt axis 80, is generally not permitted.

In the example illustrated, the body 70 houses the nut 72 in secure arrangement, with an interior of the body 70 being complementary in shape to an exterior of the nut 72 (e.g., the nut 72 may have a square profile). The clip 74 may be secured to the interior of the body 70 (e.g., by interference fit) and retains the nut 72 in the body 70. As illustrated, the clip 74 may be generally ring-shaped and include finger pins (FIG. 4) for releasing the clip 74 from a seated position in a groove in the interior of the body 70. If the nut 72 becomes stripped or otherwise damaged, it may be removed from the body 70 by first releasing the clip 74, and replaced with another one.

In use, tightening the bolt 60 relative to the nut 72 about the bolt axis 80 causes the brace plates 66, 68 to be drawn toward the brace plate 64. Accordingly, the flange surfaces 38a, 30c bear against one another, securing the panels 10a, 10c together. The bolt axis 80 may be generally orthogonal to a plane defined by the upper surfaces 12a, 12c, and the flange surfaces 30c, 38a, which may promote the flange surfaces 38a, 30c bearing against one another in a generally uniform manner about the connector assembly 54.

Because the nut 72 is fixed in position, fastening the bolt 60 to the nut 72 is simplified because manipulation of the nut 72 is not required. Also, because the head 62 of the bolt 60 is accessible from above the upper surfaces 12a, 12c, the second connection element 58 may be installed relatively quickly, through the aperture 52, and fastened to the first connection element 50 while the panels 10a, 10c lie in adjoining position.

Furthermore, because of the threaded engagement between the bolt 60 and the nut 72, the connector assembly 54 allows for adjustability. In use, for example, it may be difficult to ensure that the lower surfaces 14a, 14c of the adjacent panels 10a, 10c are aligned exactly in parallel, in situations where there is deviation in the ground surface where the panels 10a, 10c are being installed. The connector assembly 54 may accommodate this deviation because, even with misalignment of the lower surfaces 14a, 14c, the bolt 60 may be tightened to the nut 72 to secure the panels 10a, 10c together. In other words, the connector assembly 54 may secure the panels 10a, 10c together even when the flange surface 38a is spaced apart from the flange surface 30c. In situations where the ground surface is approximately flat, the bolt 60 may be tightened to the nut 72 with a relatively high amount of torque, so that the flange surfaces 38a, 30c engage and bear against one another, resulting in a relatively rigid connection between the panels 10a, 10c. Due to the threaded engagement between the bolt 60 and the nut 72, the amount of torque applied to the bolt 60 may be adjusted by the operator as desired.

Referring again to FIG. 2, the panel 10 includes a plurality of cavities 76, which as illustrated may be spaced apart across the lower surface 14 in a repeating pattern or array. The cavities 76 depend inwardly from the lower surface 14. In the example illustrated, the cavities 76 are formed by sidewalls 78 (FIG. 5) that extend generally between the upper and lower surfaces 12, 14. The cavities 76 serve to reinforce the panel 10 by forming a generally rigid structure between the upper and lower surfaces 12, 14. Although the cavities 76 are shown to have a hexagonally shaped profile, other geometric shapes and configurations are possible.

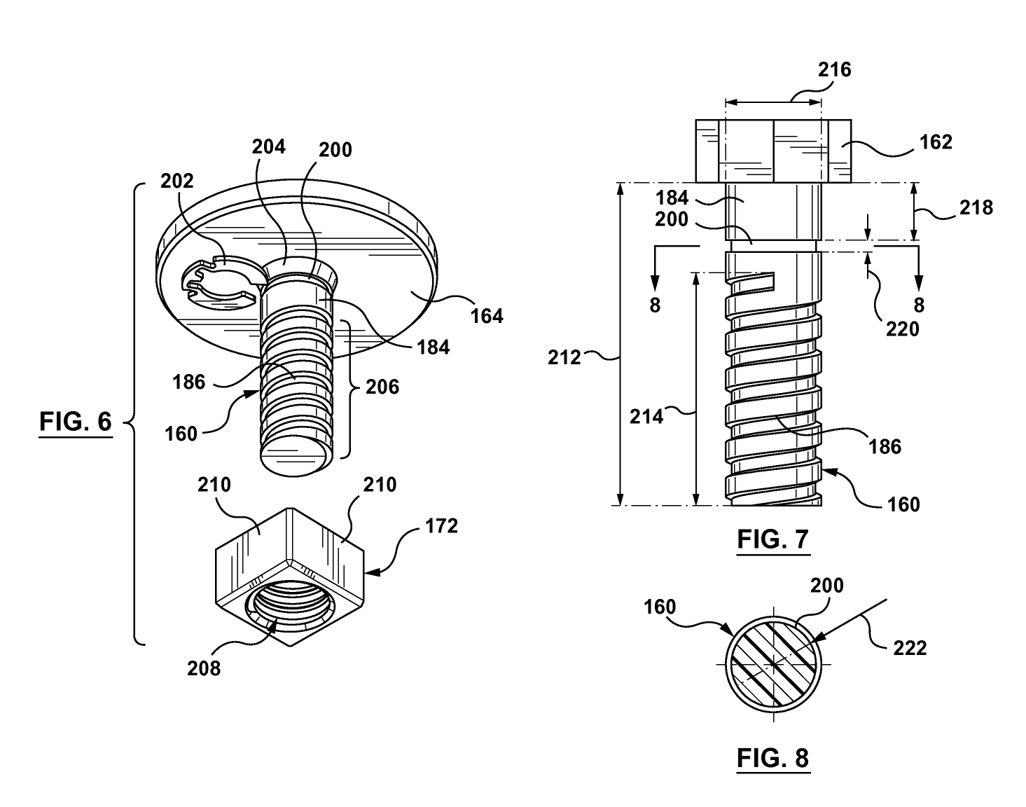

Referring now to FIG. 6, another example of a bolt 160 is shown to include a shaft portion 184 and a threaded portion 186. In the example illustrated, the shaft portion 184 includes an annular groove 200 for receiving a brace plate clip 202. The brace plate clip 202 may bear against a bottom bevel edge 204 of a brace plate 164, and retain the brace plate 164 in position relative to the head 162, which may simplify installation.

In the example illustrated, the threaded portion 186 includes coil threads 206. A nut 172 is shown to include an interior 208, which includes threads that are complementary to the coil threads 206. Use of the coil threads 206 may reduce the number of turns of the bolt 160 required to obtain a desired level of torque. In the example illustrated, the nut 172 is generally cube-shaped, and includes four torque transfer surfaces 210.

Various dimensions of the bolt 160 are illustrated in FIGS. 7 and 8. Dimensions for a particular example of the bolt 160 are provided in Table 1. These dimensions are intended to be illustrative but non-limiting.

TABLE 1

| Dimension | Reference | Inches (mm) | |
|---|---|---|---|
| Bolt height | 212 | 3.375 | (85.725) |
| Thread height | 214 | 2.38 | (60.325) |
| Thread diameter | 216 | 1.00 | (25.400) |
| Shaft height | 218 | 0.60 | (15.240) |
| Groove height | 220 | 0.125 | (3.180) |
| Groove diameter | 222 | 0.886 | (22.504) |

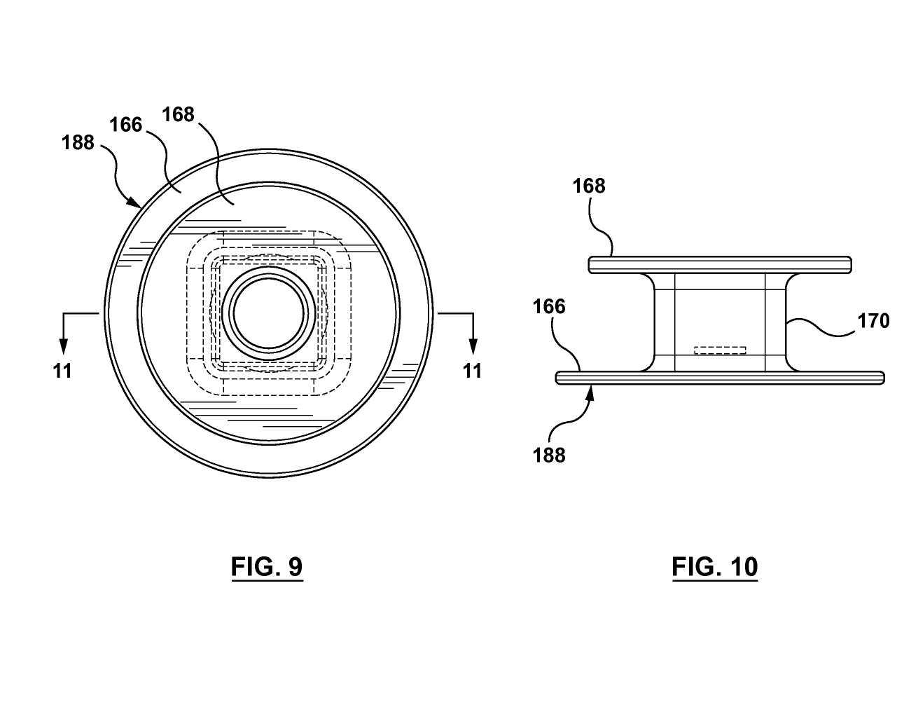

Referring to FIGS. 9 and 10, another example of a connector hub 188 is shown to include brace plates 166, 168, and a body 170 arranged between the brace plates 166, 168. The connector 188 hub may be used for connecting panels that have a thickness of approximately 4″, for example, as compared to the connector hub 88 (FIG. 4), which may be used to connect panels that are approximately 6″ thick.

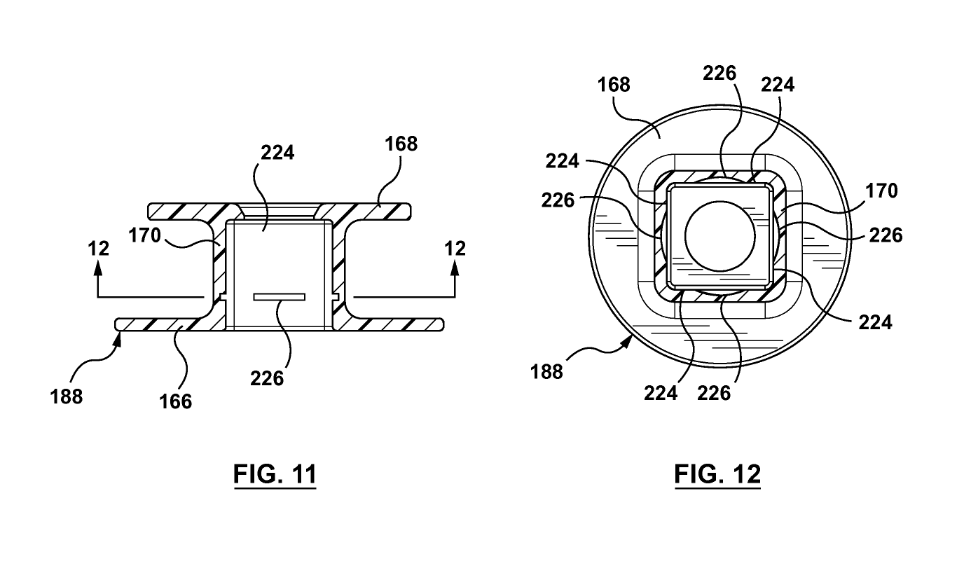

Referring to FIGS. 11 and 12, an interior of the body 170 includes a plurality of interior sidewalls 224. In the example illustrated, there are four of the sidewalls 224, each corresponding to a respective one of the torque transfer surfaces 210 of the nut 172. Each of the torque transfer surfaces 210 may be arranged to bear against a respective one of the sidewalls 224 to prevent rotation of the nut 172 relative to the body 170.

Each of the sidewalls 224 is shown to include a semi-circular groove 226. The clip (e.g., the clip 74) may be generally ring-shaped and may be seated position in the grooves 226 for retaining the nut 172 in the body 170.

Each of the bolt 160, the nut 172, and the connector hub 188 may be formed of hot-dip galvanized steel.

While the above description provides examples of one or more apparatuses or methods, it will be appreciated that other apparatuses or methods may be within the scope of the accompanying claims.

I claim:

1. A system for constructing a load bearing surface, comprising:
at least first and second modular ground covering panels, each of the panels comprising upper and lower surfaces, wherein along at least one first side edge of each of the panels the lower surface projects beyond the upper surface to define a lower peripheral tab, wherein along at least one second side edge of each of the panels the upper surface projects beyond the lower surface to define an upper peripheral tab, and wherein the lower peripheral tab of one of the panels and the upper peripheral tab of another one of the panels are configured to overlappingly engage so that the upper surfaces of the panels are in adjoining relation to form the load bearing surface; and
at least one connector assembly comprising a first connection element fixed to the lower peripheral tab, and a second connection element that releasably fastens the upper peripheral tab to the first connection element to secure the panels together,
wherein the upper peripheral tab comprises at least one aperture, and the second connection element comprises a bolt that extends through the aperture,
wherein a head of the bolt is accessible from above the upper surfaces of the panels,
wherein the first connection element comprises a nut configured to receive the bolt, and the nut is retained in position relative to the lower peripheral tab so that rotation of the nut about a bolt axis is not permitted, and
wherein the bolt and the nut comprise complementary threads that facilitate the second connection element being releasably fastened to the first connection element.

2. The system of claim 1, wherein the lower peripheral tab comprises a first flange surface, and the upper peripheral tab comprises a second flange surface, and tightening the bolt relative to the nut causes the flange surfaces to bear against one another in opposed relation.

3. The system of claim 2, wherein the flange surfaces are generally parallel to a plane defined by the upper surfaces of the panels.

4. The system of claim 3, wherein the connector assembly comprises at least one brace plate for distributing forces to at least one of the peripheral tabs.

5. The system of claim 4, wherein the second connection element comprises a first brace plate arranged between the head of the bolt and the upper peripheral tab, the upper peripheral tab comprises a recess generally surrounding the aperture, and the first brace plate is received within the recess.

6. The system of claim 5, wherein the first connection element comprises a second brace plate that is mounted to the lower peripheral tab, the lower peripheral tab comprises a recess generally surrounding the first connection element, and the second brace plate is received within the recess.

7. The system of claim 6, wherein the first connection element comprises a third brace plate that is mounted to the first flange surface, the first flange surface comprises a recess generally surrounding the first connection element, and the third brace plate is received within the recess.

8. The system of claim 7, wherein tightening the bolt relative to the nut draws the second and third brace plates towards the first brace plate, thereby securing the peripheral tabs together.

9. The system of claim 1, wherein the first connection element comprises a body housing the nut in secure arrangement.

10. The system of claim 9, wherein the nut comprises a plurality of torque transfer surfaces, and an interior of the body comprises a plurality of sidewalls, each of the torque transfer surfaces being arranged to bear against a respective one of the sidewalls to prevent rotation of the nut relative to the body.

11. The system of claim 10, wherein the first connection element comprises a clip configured to retain the nut in the body, and the clip is releasable so that the nut is removable from the body.

12. The system of claim 11, wherein at least one of the sidewalls comprises a groove, and the clip is releasably seated in the groove for retaining the nut in the body.

13. The system of claim 1, comprising a plurality of the connector assemblies spaced apart along the adjoined side edges of the panels.

14. A load bearing surface constructed using the system of claim 1.

15. In combination:
a first panel comprising upper and lower surfaces and side edges, and along at least one first side edge the lower surface projects beyond the upper surface to define a lower peripheral tab;
a second panel comprising upper and lower surfaces and side edges, along at least one second side edge the upper surface projects beyond the lower surface to define an upper peripheral tab, the upper peripheral tab comprising an aperture, and the upper peripheral tab is configured to overlappingly engage the lower peripheral tab of the first panel so that the upper surfaces of the first and second panels are in adjoining relation to form a load bearing surface; and
a connector assembly comprising a nut retained in position relative to the lower peripheral tab so that rotation of the nut about a bolt axis is not permitted, and a bolt that extends through the aperture of the upper peripheral tab, the nut and the bolt comprising complementary threads that facilitate releasably fastening the upper peripheral tab of the second panel to the lower peripheral tab of the first panel to secure the panels together.

16. The combination of claim 15, wherein an interior of the body is complementary in shape to an exterior of the nut, and the nut is removable from the body.

17. The combination of claim 16, wherein the nut comprises a plurality of torque transfer surfaces, and the interior of the body comprises a plurality of sidewalls, each of the torque transfer surfaces being arranged to bear against a respective one of the sidewalls to prevent rotation of the nut relative to the body.

18. The combination of claim 17, wherein at least one of the sidewalls comprises a groove, and further comprising a clip that is releasably seated in the groove for retaining the nut in the body.

19. A connector assembly for connecting first and second modular ground covering panels, a lower peripheral tab of the first modular ground covering panel and an upper peripheral tab of the second modular ground covering panel overlappingly engage so that upper surfaces of the first and second modular ground covering panels are in adjoining relation to form a load bearing surface, the connector assembly comprising:
a bolt comprising a head and a threaded portion;
a connector hub comprising a body, an interior of the body comprising a plurality of sidewalls, at least one of the sidewalls comprising a groove;
a nut removingly received by the body, the nut comprising an interior with threads that are complementary to the threaded portion of the bolt, and an exterior with a plurality of torque transfer surfaces, each of the torque transfer surfaces being arranged to bear against a respective one of the sidewalls to prevent rotation of the nut relative to the body;
a clip releasably seated in the groove for retaining the nut in the body;
whereby, upon assembly, the head is accessible from above the upper surfaces of the panels, the bolt extends through an aperture in the upper peripheral tab, the connector hub is fixed to the lower peripheral tab, and tightening the bolt relative to the nut about a bolt axis secures the first and second modular ground covering panels together.

20. The connector assembly of claim 19, further comprising a brace plate and a brace plate clip, and wherein the bolt further comprises a shaft portion arranged between the head and the threaded portion, the shaft portion comprising an annular groove, and the brace plate clip is received by the annular groove to retain the brace plate in position relative to the head.
